(19) United States
(12) Patent Application Publication
(10) Pub. No.: US 2024/0039991 A1
(43) Pub. Date: Feb. 1, 2024

(54) AUTOMATED BORESCOPE DATA SYNCHRONIZATION

(71) Applicant: Baker Hughes Holdings LLC, Houston, TX (US)

(72) Inventors: Sheldon McCrackin, Yukon, OK (US); Kevin Coombs, Syracuse, NY (US); Kevin Frederickson, Chicago, IL (US)

(21) Appl. No.: 18/359,749

(22) Filed: Jul. 26, 2023

Related U.S. Application Data
(60) Provisional application No. 63/370,052, filed on Aug. 1, 2022.

(51) Int. Cl. H04L 67/1095; G01N 21/88

(52) U.S. Cl. CPC H04L 67/1095; G01N 21/88; H04L 67/12

(57) ABSTRACT

A first set of data is received by a non-destructive testing device (NDT device) from a remote system. A second set of data is received by the NDT device from a sensor on the NDT device. In response to receiving the second set of data, the first set of data and the second set of data are synchronized to create a synchronized set of data by comparing the first set of data and the second set of data, identifying differences between the first set of data and the second set of data, and providing a set of data that include elements of both the first set of data and the second set of data. Synchronizing occurs automatically during an inspection. The synchronizing occurs between the NDT device and the remote system such that the synchronized set of data is present on both the NDT device and the remote system.

### CROSS REFERENCE TO RELATED APPLICATIONS

The present application claims priority under 35 U.S.C. § 119 to U.S. Provisional Patent Application No. 63/370,052, filed Aug. 1, 2022, and entitled “Automated Borescope Data Upload,” which is hereby incorporated by reference in its entirety.

### TECHNICAL FIELD

This disclosure relates to automating data synchronization from inspection equipment.

### BACKGROUND

A large amount of data is captured and generated during borescope inspections. This includes imagery and corresponding 3D data, measurements, human or computer-generated annotations and indications, menu driven inspection (MDI) metadata, and other metadata associated with the inspection. In typical operations, such data is stored on the borescope or a memory card within a borescope. The data is then transferred to a personal computer or server once the borescope has completed inspection operations and has returned from the inspection location.

### SUMMARY

This disclosure relates to automating borescope data synchronization.

An example implementation of the subject matter described within this disclosure is a method with the following features. A first set of data is received by a non-destructive testing device (NDT device) from a remote system. A second set of data is received by the NDT device from a sensor on the NDT device. In response to receiving the second set of data, the first set of data and the second set of data are synchronized to create a synchronized set of data by comparing the first set of data and the second set of data, identifying differences between the first set of data and the second set of data, and providing a set of data that include elements of both the first set of data and the second set of data. Synchronizing occurs automatically during an inspection. The synchronizing occurs between the NDT device and the remote system such that the synchronized set of data is present on both the NDT device and the remote system.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

Aspects of the example method, which can be included with the example method alone or in combination with other aspects, include the following. The NDT device is a first NDT device and the synchronized set of data is a first synchronized set of data. The method further includes the following features. The first set of data is received by a second NDT device from the remote system. A third set of data is received by the second NDT device from a sensor on the NDT device. In response to receiving the third set of data, the first set of data, the second set of data, and the third set of data are synchronized to create a second synchronized set of data automatically during the inspection between the first NDT device, the second NDT device, and the remote system such that the second set of synchronized set of data is present on the first NDT device, the second NDT device, and the remote system.

Aspects of the example method, which can be included with the example method alone or in combination with other aspects, include the following. Synchronizing the data first set of data and the second set of data includes providing, by the NDT device, the second set of data, which characterizes information contents of the NDT device, to the remote system.

Aspects of the example method, which can be included with the example method alone or in combination with other aspects, include the following. Receiving the first set of data from the remote system includes providing the first set of data, characterizing an inspection template, to the NDT device from the remote system.

Aspects of the example method, which can be included with the example method alone or in combination with other aspects, include the following. Receiving data from the sensor includes performing an inspection.

Aspects of the example method, which can be included with the example method alone or in combination with other aspects, include the following. The synchronized set of data includes an images or video, metadata, annotations made by an inspector, and/or measurements.

Aspects of the example method, which can be included with the example method alone or in combination with other aspects, include the following. The synchronized data comprises a specified file naming nomenclature.

### BRIEF DESCRIPTION OF DRAWINGS

FIG. 1 is a flowchart of an example method that can be used with aspects of this disclosure.

FIG. 2 is a block diagram of example communications that can be used with aspects of this disclosure.

FIG. 3 is a block diagram of an example controller.

FIG. 4 is a diagram of a borescope.

### DETAILED DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

Backup and synchronization of data on non-destructive testing (NDT) devices, such as borescope data from a borescope, is currently a manual process. This this can be done with a Graphic User Interface (GUI) to navigate to the data to be synchronized, then either uploading the data to a remote server or copy the data to a larger external drive. This is time consuming, inefficient, and prone to human error. A large amount of data is captured and generated during NDT inspections. Such data can includes imagery and corresponding 3D data, measurements, human or computer-generated annotations, menu driven inspection (MDI) metadata, and other metadata associated with the inspection.

This disclosure describes how this large amount of data from one or more NDT devices can be continuously synchronized to a remote system automatically, without the need for user input. Data from the NDT device is synchronized to the remote system. The data can include measurement images (image and corresponding 3D data). Alternatively or in addition, the data can include annotations and indications, generated from human input and/or image processing algorithms and information required to create, modify, or delete annotations and indications. Alternatively or in addition, the data can include MDI inspections including MDI templates, images, reports, and all information required to resume the MDI inspection. Alternatively or in addition, the software will upload other videos and images saved to the device.

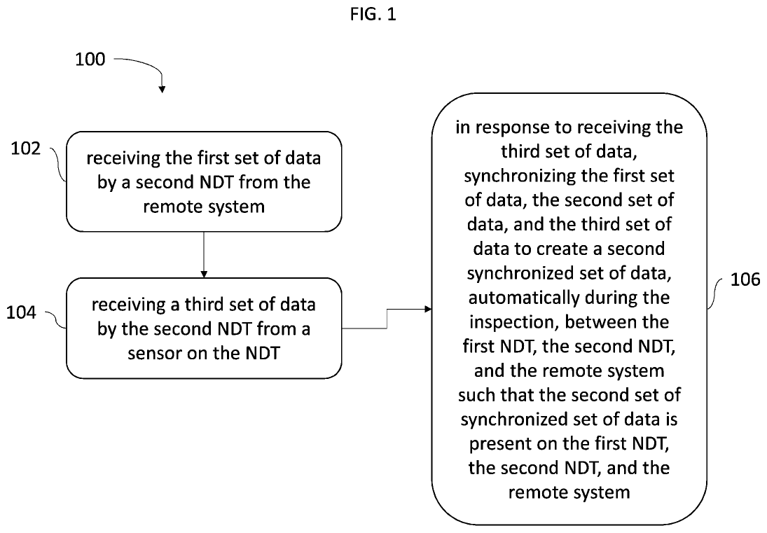

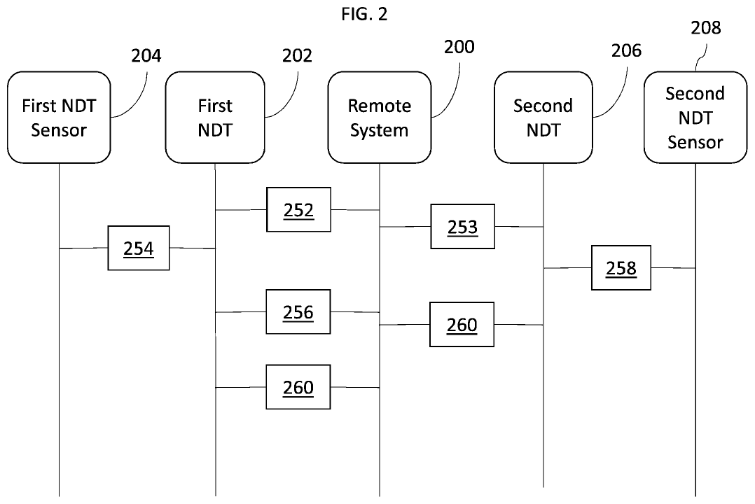

FIG. 1 is a flowchart of an example method 100 that can be used with aspects of this disclosure. At 102, a first set of data is received by a non-destructive testing (NDT) device from a remote system. Communications between the various components described within this disclosure are illustrated in FIG. 2. Receiving the first set of data from the remote system can include providing the first set of data, characterizing an inspection template, to the NDT device from the remote system. The remote system can come in many forms, such as a remote server, a cloud server, a remote hard-drive, or any device having a non-transitory memory/storage capable of communicating with the NDT device from a remote location.

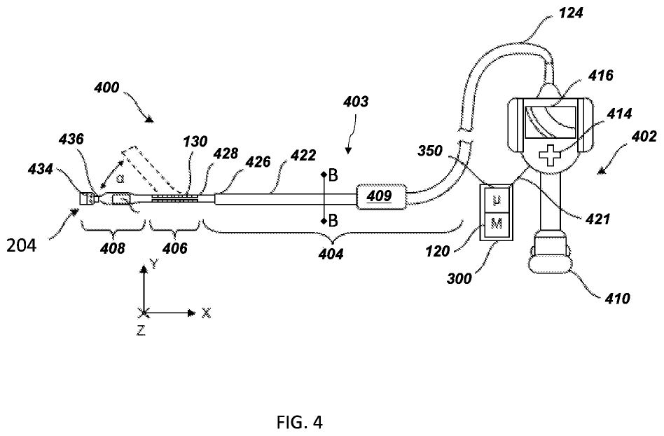

At 104, a second set of data is received by the NDT device from a sensor on the NDT device. Receiving such data from the sensor can occur, for example, when performing an inspection with the NDT device. An example of such an NDT device is illustrated and described with respect to FIG. 4.

At 106, in response to receiving the second set of data, the first set of data and the second set of data are synchronized to create a synchronized set of data. To accomplish this, the first set of data and the second set of data are compared, and any differences between the first set of data and the second set of data are identified. Then, a set of data that includes elements of both the first set of data and the second set of data is provided. Such synchronization occurs automatically during an inspection. The synchronizing occurs between the NDT device and the remote system such that the synchronized set of data is present on both the NDT device and the remote system. While described thus far as synchronizing between a single NDT device and a remote system, as described later, additional NDT device devices can be synchronized with the remote system and/or with each other. In some implementations, synchronizing the data first set of data and the second set of data includes providing the second set of data, which characterizes information contents of the NDT device, to the remote system from and by the NDT device. The resulting synchronized set of data can include the inspection template, images or video, metadata, annotations made by an inspector, and/or measurements. Alternatively or in addition, the synchronized data can include a specified file naming nomenclature. Such a file naming nomenclature can include information such as a date, a location, the NDT device used, or other identifying information. Alternatively or in addition, metadata can be used to store such information.

FIG. 2 is a block diagram of example communications that can be used with aspects of this disclosure. The first set of data 252 is sent from the remote system 200 to the NDT device 202. Once an inspection begins, the second set of data 254 is received by the NDT device 202 from the NDT device sensor 204. The first set of data 252 and the second set of data 254 are then synchronized to create the synchronized set of data 256 that is exchanged between the remote system 200 and the NDT device 202. This process is repeated during inspection operations as more data is acquired by the sensor 204.

In some embodiments, a second NDT device 206 is used jointly with the first NDT device 202 during inspection operations. In such instances, the first set of data 253 is received by a second NDT device 206 from the remote system 200. The first set of data 253 received by the second NDT device 206 can be identical to, similar to, or different from the first set of data 252 received by the first NDT device 202. For example, the first set of data 253 received by the second NDT device 206 can include a template for a different inspection route, or a same template for a same inspection route as is received by the first NDT device 202. Once inspection operations are underway, a third set of data 258 is received by the second NDT device 206 from a sensor 208 on the second NDT device 206. In response to receiving the third set of data 258, the first set of data (252, 253), the second set of data 254, and the third set of data 258 can then be synchronized to create a second synchronized set of data 260. This second synchronized set of data 260 is then automatically synchronized between the first NDT device 202, the second NDT device 206, and the remote system 200 such that the second set of synchronized set of data 260 is present on the first NDT device 202, the second NDT device 206, and the remote system 200. Such synchronization occurs automatically during the inspection.

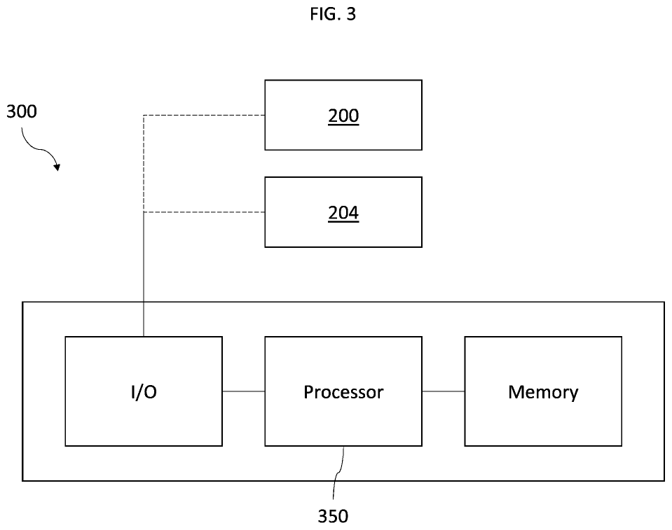

FIG. 3 illustrates the example controller 300 that can be used with some aspects of the current subject matter, for example, as a controller for the NDT device 202. In some implementations, the controller can execute all or part of the method 100 described throughout this disclosure. The controller 300 can, among other things, monitor parameters of a system, send signals to actuate and/or adjust various operating parameters of such systems. As shown in FIG. 3, the controller 300 can include one or more processors 350 and non-transitory computer readable memory storage (e.g., memory 352) containing instructions that cause the processors 118 to perform operations. The processors 118 are coupled to an input/output (I/O) interface 354 for sending and receiving communications with components in the system, including, for example, the sensor 109 and/or the remote system 200. In some implementations, the I/O interface 354 can include a wireless communication device. In certain instances, the controller 300 can additionally communicate status with and send actuation and/or control signals to one or more of the various system components (including, for example, a light source or actuation system of the NDT device 202) of the system, as well as other sensors (e.g., pressure sensors, temperature sensors, vibration sensors and other types of sensors) that provide signals to the system.

The controller 300 can be implemented with various levels of autonomy. For example, in some instances, the controller 300 determines a set of data on the NDT device 202 is different from a set of data on the remote system 200, prompts an operator of the NDT device 202, and can synchronize the data based on an input from the operator. Alternatively or in addition, the controller 300 can determine that a set of data on the NDT device 202 is different from a set of data on the remote system 200, and can then synchronize the data with no input from the operator. The controller can also alert the operator if other conditions are met, for example, in instances where it is determined that a memory of the controller 300 is at or above a specified threshold (for example, 90%), the controller 300 may alert an operator and/or cease automatic synchronization operations without input from the operator.

FIG. 4 is a diagram illustrating an example NDT device in the form of a borescope 400. The borescope 400 can include a control unit 402 and an inspection tube 403. The inspection tube 403 can include a conduit section 404, a bendable, actuable articulation portion or section 406, and an inspection head 408. In one embodiment, the sections 404, 406, 408 can have different lengths and can be integral with one another, or can be detachable from one another. As depicted, the conduit section 404 is suitable for insertion into a variety of different targets, such as inside turbomachinery, equipment, pipes, conduits, underwater locations, curves, bends, inside or outside of an aircraft system, and the like.

The borescope 400 can include a probe driver 409 coupled to the conduit section 404. The probe driver 409 can include actuators (not shown) configured to translate and/or rotate one or more of the sections 404, 406, 408 (e.g., to facilitate insertion of the inspection head 408 into the target). Additionally or alternatively, orientation/position of a portion of the inspection head 408 (e.g., camera, light source, etc.) can be varied to acquire an inspection region image (e.g., RGB image, IR image, etc.). The control unit 402 can include a control unit housing 410, a controller 300, a directional input 414, and a screen 416. As previously discussed, the controller 300 can include a processor 350 and a readable memory 352 containing computer readable instructions which can be executed by the processor 350 in order to actuate the borescope 400. The computer readable instructions can include an inspection plan based on which the borescope 400 or a portion thereof (e.g., a conduit section 404, a bendable articulation section 406, and an inspection head 408) can be translated/rotated (e.g., by the probe driver 409). In some implementations, the operation of the probe driver 409 can be based on a control signal (e.g., generated by the controller 300 based on the inspection plan/user input via GUI display space on screen 416 or a computing device, etc.).

The controller 300 can be communicatively coupled to the control unit 402 via one or more cables 421. The controller 300 can also be arranged within the control unit housing 410, or can be arranged outside the control unit housing 410. On some implementations, the directional input 414 can be configured to receive user input (e.g., direction controls) to the control unit 402 for actuation of the borescope 400. The screen 416 can display visual information being received by the camera (including an optical sensor) arranged in the inspection head 408, which can allow the user to better guide the borescope 400 using the directional input 414. The directional input 414 and the screen 416 can be communicatively coupled to the controller 300 via the one or more cables 421, which can be a hard-wired connection or a wireless signal, such as WI-FI or Bluetooth. In one implementation, inspection data and/or notifications (e.g., notifications based on inspection data as described above) can be provided on the screen 416. More details on the controller 300 are described later in this disclosure.

The conduit section 404 can include a tubular housing 422 including a proximal end 424 and a distal end 426. The tubular housing 422 can be a flexible member along its whole length, or can be rigid at the proximal end 424 and become more flexible travelling down the length of the conduit section 404 towards the distal end 426. In certain embodiments, the tubular housing 422 can be formed from a non-porous material to prevent contaminants from entering the borescope 400 via the conduit section 404.

The control unit 402 can be arranged at the proximal end 424 of the tubular housing 422, and the bendable articulation section 406 can be arranged at the distal end of the tubular housing 422. The bendable articulation section 406 can include a bendable neck 428 and washers 130. The bendable neck 428 can be arranged at the distal end 426 of the tubular housing 422, and is able to be actuated 3600 in the Y-Z plane. The bendable neck 428 can be wrapped in a non-porous material to prevent contaminants from entering the borescope 400 via the bendable articulation section 406.

The inspection head 408 can include a light source 434 (e.g., LEDs or a fiber optic bundle with lights at the proximal end), a camera 436 (or multiple cameras such as visible-light camera, IR camera, etc.), and one or more sensors 204 that can be configured to collect data about the surrounding environment. The camera 436 of the borescope 400 can provide images and video suitable for inspection to the screen 416 of the control unit 402. The light source 434 can be used to provide for illumination when the inspection head 408 is disposed in locations having low light or no light. The sensor 204 can record data including temperature data, distance data, clearance data (e.g., distance between a rotating element and a stationary element), flow data, and so on.

In certain embodiments, the borescope 400 includes one or more replacement inspection heads 408. The inspection head 408 can include tips having differing optical characteristics, such as focal length, stereoscopic views, 3-dimensional (3D) phase views, shadow views, etc. Additionally or alternatively, the inspection head 408 can include a removable and replaceable portion of the inspection head 408. Accordingly, the head sections 408, bendable necks 428, and conduit section 404 can be provided at a variety of diameters from approximately one millimeter to ten millimeters or more.

During use, the bendable articulation section 406 and the probe driver 409 can be controlled, for example, by the control inputs (e.g., relative control gestures, physical manipulation device) from the directional input 414 and/or control signals generated by the controller 300. The directional input can be a joystick, D-pad, touch pad, trackball, optical sensor, or a touchscreen over the screen 416. The directional input 414 can also be a similar device that is located outside the control unit housing 410 and connected by wire or wireless means. In particular, a set of control inputs can be used to control the bendable articulation section 406 and/or the probe driver 409. The bendable articulation section 406 can steer or “bend” in various dimensions, while the conduit section 404 can translate and/or rotate, using any combination of actuators and wires arranged within the control unit 402, to adjust the orientation (e.g., a positioning) of the inspection head 408. In some implementations, the control inputs/direction input 414 can be generated by the controller based on an inspection plan.

The actuators can be electric, pneumatic, or ultrasonically operated motors or solenoids, shape alloy, electroactive polymers, dielectric elastomers, polymer muscle material, or other materials. For example, the bendable articulation section 406 and the probe driver 409 can enable movement of the inspection head 408 in an X-Y plane, X-Z plane, and/or Y-Z plane. Indeed, the directional input 414 can be used to perform control actions suitable for disposing the inspection head 408 at a variety of angles, such as the depicted angle α. In this manner, the inspection head 408 can be positioned to visually inspect desired locations.

Once the inspection head 408 is in a desired position, the camera 436 can operate to acquire, for example, a stand-still visual image or a continuous visual image, which can be displayed on the screen 416 of the control unit 402, and can be recorded by the borescope 400. In embodiments, the screen 416 can be multi-touch touch screens using capacitance techniques, resistive techniques, infrared grid techniques, and the like, to detect the touch of a stylus and/or one or more human fingers. Additionally or alternatively, acquired visual images can be synchronized with the remote system 200 for later reference.

In some embodiments, source code can be human-readable code that can be written in program languages such as python, C++, etc. In some embodiments, computer-executable codes can be machine-readable codes that can be generated by compiling one or more source codes. Computer-executable codes can be executed by operating systems (e.g., Linux, windows, mac, etc.) of a computing device or distributed computing system. For example, computer-executable codes can include data needed to create runtime environment (e.g., binary machine code) that can be executed on the processors of the computing system or the distributed computing system.

Other embodiments are within the scope and spirit of the disclosed subject matter. For example, the method of generating consolidate dataset described in this application can be used in facilities that have complex machines with multiple operational parameters. Usage of the word “optimize”/“optimizing” in this application can imply “improve”/“improving.”

Certain embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an embodiment of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving a first set of data by a non-destructive testing (NDT) device from a remote system;
receiving a second set of data by the NDT device from a sensor on the NDT device; and
in response to receiving the second set of data, synchronizing the first set of data and the second set of data to create a synchronized set of data, by comparing the first set of data and the second set of data, identifying differences between the first set of data and the second set of data, and providing a set of data that include elements of both the first set of data and the second set of data, wherein synchronizing occurs automatically during an inspection, wherein the synchronizing occurs between the NDT device and the remote system such that the synchronized set of data is present on both the NDT device and the remote system.

2. The method of claim 1, wherein the NDT device is a first NDT device and the synchronized set of data is a first synchronized set of data, the method further comprising:
receiving the first set of data by a second NDT device from the remote system;
receiving a third set of data by the second NDT device from a sensor on the NDT device; and
in response to receiving the third set of data, synchronizing the first set of data, the second set of data, and the third set of data to create a second synchronized set of data, automatically during the inspection, between the first NDT device, the second NDT device, and the remote system such that the second set of synchronized set of data is present on the first NDT device, the second NDT device, and the remote system.

3. The method of claim 1, wherein synchronizing the data first set of data and the second set of data comprises:
providing, by the NDT device, the second set of data, which characterizes information contents of the NDT device, to the remote system.

4. The method of claim 1, wherein receiving the first set of data from the remote system comprises:
providing the first set of data, characterizing an inspection template, to the NDT device from the remote system.

5. The method of claim 1, wherein receiving data from the sensor comprises:
performing an inspection.

6. The method of claim 1, wherein the synchronized set of data comprises:
an images or video;
metadata;
annotations made by an inspector; or
measurements.

7. The method of claim 1, wherein the synchronized data comprises a specified file naming nomenclature.

8. A system comprising:
at least one data processor; and
non-transitory memory storing instructions, which, when executed by the at least one data processor causes the at least one data processor to perform operations comprising:
receiving a first set of data by a non-destructive testing (NDT) device from a remote system;
receiving a second set of data by the NDT device from a sensor on the NDT device; and
in response to receiving the second set of data, synchronizing the first set of data and the second set of data to create a synchronized set of data, by comparing the first set of data and the second set of data, identifying differences between the first set of data and the second set of data, and providing a set of data that include elements of both the first set of data and the second set of data, wherein synchronizing occurs automatically during an inspection, wherein the synchronizing occurs between the NDT device and the remote system such that the synchronized set of data is present on both the NDT device and the remote system.

9. The system of claim 8, wherein the NDT device is a first NDT device and the synchronized set of data is a first synchronized set of data, the operations further comprising:
receiving the first set of data by a second NDT device from the remote system;
receiving a third set of data by the second NDT device from a sensor on the NDT device; and
In response to receiving the third set of data, synchronizing the first set of data, the second set of data, and the third set of data to create a second synchronized set of data, automatically during the inspection, between the first NDT device, the second NDT device, and the remote system such that the second set of synchronized set of data is present on the first NDT device, the second NDT device, and the remote system.

10. The system of claim 8, wherein synchronizing the data first set of data and the second set of data comprises:
providing, by the NDT device, the second set of data, which characterizes information contents of the NDT device, to the remote system.

11. The system of claim 8, wherein receiving the first set of data from the remote system comprises:
providing the first set of data, characterizing an inspection template, to the NDT device from the remote system.

12. The system of claim 8, wherein receiving data from the sensor comprises:
performing an inspection.

13. The system of claim 8, wherein the synchronized set of data comprises:
an images or video;
metadata;
annotations made by an inspector; or
measurements.

14. The system of claim 8, wherein the synchronized data comprises a specified file naming nomenclature.

15. A non-transitory computer readable memory storing instructions which, when executed by at least one data processor forming part of at least one computing system, causes the at least one data processor to perform operations comprising:
receiving a first set of data by a non-destructive testing (NDT) device from a remote system;
receiving a second set of data by the NDT device from a sensor on the NDT device; and
in response to receiving the second set of data, synchronizing the first set of data and the second set of data to create a synchronized set of data, by comparing the first set of data and the second set of data, identifying differences between the first set of data and the second set of data, and providing a set of data that include elements of both the first set of data and the second set of data, wherein synchronizing occurs automatically during an inspection, wherein the synchronizing occurs between the NDT device and the remote system such that the synchronized set of data is present on both the NDT device and the remote system.

16. The non-transitory computer readable memory of claim 15, wherein the NDT device is a first NDT device and the synchronized set of data is a first synchronized set of data, the operations further comprising:
receiving the first set of data by a second NDT device from the remote system;
receiving a third set of data by the second NDT device from a sensor on the NDT device; and
in response to receiving the third set of data, synchronizing the first set of data, the second set of data, and the third set of data to create a second synchronized set of data, automatically during the inspection, between the first NDT device, the second NDT device, and the remote system such that the second set of synchronized set of data is present on the first NDT device, the second NDT device, and the remote system.

17. The non-transitory computer readable memory of claim 15, wherein synchronizing the data first set of data and the second set of data comprises:
providing, by the NDT device, the second set of data, which characterizes information contents of the NDT device, to the remote system.

18. The non-transitory computer readable memory of claim 15, wherein receiving the first set of data from the remote system comprises:
providing the first set of data, characterizing an inspection template, to the NDT device from the remote system.

19. The non-transitory computer readable memory of claim 15, wherein the synchronized set of data comprises:
an images or video;
metadata;
annotations made by an inspector; or
measurements.

20. The non-transitory computer readable memory of claim 15, wherein the synchronized data comprises a specified file naming nomenclature.
